(19) United States
(12) Patent Application Publication
(10) Pub. No.: US 2022/0001306 A1
(43) Pub. Date: Jan. 6, 2022

(54) LIQUID FILTERATION SYSTEM

(71) Applicant: Atharv N. Naidu, Foster City, CA (US)

(72) Inventor: Atharv N. Naidu, Foster City, CA (US)

(21) Appl. No.: 17/481,308

(22) Filed: Sep. 22, 2021

Related U.S. Application Data
(60) Provisional application No. 63/228,132, filed on Aug. 1, 2021.

(51) Int. Cl. B01D 24/22; B01D 24/00; B01D 24/48; B01D 24/38; C02F 1/00; E02B 15/04

(52) U.S. Cl. CPC B01D 24/22; B01D 24/008; B01D 24/4869; B01D 24/4853; C02F 2103/002; C02F 1/001; C02F 1/008; E02B 15/045; B01D 24/386

(57) ABSTRACT

The present invention discloses a filtration system for treating untreated liquid such as greywater or any liquid that is contaminated with impurity and is required to be treated before use. The filtration system is a gravity fed liquid treatment system and includes components such as a top liquid tank for holding untreated liquid and a bottom liquid tank for holding treated liquid. The filtration system further includes one or more filtration media containers and filtration columns. Each filtration column is a composition of the stacked filtration media containers. The filtration system may be used for cleaning the contaminated water or keeping clear the surface of open water from oil or the like floating materials by separating or removing these materials from the water. The filtration system may include portable or detachable small-scale multistage treatment devices and may be implemented using household-type filters for producing potable filtration system.

CROSS-REFERENCE TO RELATED PATENT DOCUMENTS

This patent application claims the benefit of priority of U.S. Provisional Application No. 63/228,132 entitled “CONNECTED COMPONENTS FILTERATION SYSTEM,” filed Aug. 1, 2021, which is hereby incorporated herein by reference in its entirety.

### FIELD OF THE INVENTION

The present application generally relates to the treatment of water, and more particularly to a filtration system that is configured to treat contaminated liquid for its purification so that the treated liquid can be used across various relevant applications. More specifically, various embodiments discussed herein generally relate to devices for cleaning the contaminated water or keeping clear the surface of open water from oil or the like floating materials by separating or removing these materials from the water. The filtration system may include portable or detachable small-scale multistage treatment devices and may be implemented using household-type filters for producing portable liquid filtration system.

### BACKGROUND

Generally, filtration systems are frequently used in a variety of settings including residential and commercial applications in which the systems are designed to remove contaminants and other impurities from a liquid supply to provide filtered liquid that is fresh and safe for various usages. One such example of liquid filtering is water filtering. Generally, water quality varies drastically globally and requires unique filtration parameters tailored to the specific properties of the water being filtered and the desired level of filtration required by the end user. Water filtration systems usually include a filter cartridge coupled to a manifold, which are usually installed in any number of locations in the water supply line. For example, a water filtration system may be installed in a refrigerator in communication with a built-in water dispenser. Additionally, a water filtration system may be installed under a countertop that supports a sink and/or faucet. Alternatively, or in addition to, a water filtration system may be employed on the faucet itself. Finally, other types of water filtration systems may be utilized at some other point in the water supply between the main water line that supplies water from a municipal or city water source to the end dispensing point (e.g., a faucet, water dispenser, etc.).

With the significant increase in the population across the world, there is an increased demand for freshwater usage. This demand results in shortage of freshwater and hence an increase in the cost. Adding to the problem are global environmental changes that also contribute to the shortage. Reusing wastewater contributes to the overall freshwater supply.

Greywater is the wastewater generated from the process of a household appliance like a kitchen sink, shower, washing machine, or AC outlet. This wastewater ends up as sewage unless treated and reused. Untreated greywater consists of organic and inorganic pollutants. An example of inorganic pollutant is lint and other suspended solids from a washing machine. Organic pollutants include microbiological pollutants like coliform and Escherichia coli. A common system to filter the untreated greywater is a column that is packed and layered with filtration media. An example of filtration media is sand, gravel, or activated carbon. Greywater that is an output of a common process like showering, bathing, or a washing machine passes into the column inlet and passed through the filtration media. Gravity helps the water flow through the column and results in treated greywater.

Various parameters define the quality of untreated greywater. An example of a parameter may be the Ph level, total dissolved solids (TPS), or measure of the number of bacteria. The parameters of untreated greywater may be different because of the differences in processes and the variation in the substances used. As an example, washing machine detergents and bleach in a washing cycle affect the parameters of untreated greywater differently from soap in a bathing process. The treatment of untreated greywater will differ with variations of the parameters of the greywater. Thus, variations in the parameters of untreated greywater implies a need for a system to flexibly manage different configurations of the filtration media in the filter column. These variations could be in the filter type, amount, or density of each packed layer of the filter column. As an example, one may need a differing quantity of activated carbon or a larger quantity of sand for filtering larger soluble particles for a particular untreated greywater. There is also a need for a system to manage different combinations of the filtration media in the column. Several types of filtration media may be assembled in various combinations. As an example, in a certain region, because of resource availability, coir then cotton may be used as filtration media combinations. In another region, pebbles then activated carbon may be used as a filtration media combination. Requirements for the untreated greywater capacity and treated greywater filtration speed is an important characteristic of the system. There is a need for a configurable system that can satisfy the untreated greywater capacity and treatment filtration speed requirements. As an example, required treatment capacity in a household may differ from required treatment capacity from a small communal farm.

There is a need for a componentized, connected components “Lego” block approach to grey water filtration systems such that a complex filtration system can be assembled with prebuilt components. These prebuilt components can be manufactured in traditional ways or 3D printed. This is especially important in areas that do not have electrification or manufacturing infrastructures and DIY is crucial.

There are several prior arts that try to solve similar problems. For example, the Japanese patent application JP2009113017A discloses a filtration apparatus for filtering test water so that test water entering a testing device for testing harmful substances in raw water of rivers and lakes water has high turbidity and does not hinder testing. In this, flanges are installed to several hollow cylinders, screwed with bolts and are connected and integrated. The raw water is introduced from downward. A back-wash pipe and an air pipe are inserted into a hollow part. Mixed water is made to pass through a gap between the back-wash pipe and the air pipe, and discharged from the T-shaped back-wash pipe to automatically clean the filtration sand normally. A funnel type filtration device consists of two funnel dishes of an upper funnel dish and a lower funnel dish, two funnel dishes are cross-linked with a connection plate. The filtration sand is packed at the angle of repose in the space, and raw water is made to pass through the filtration sand. The bottom part of the upper funnel dish has an opened hole and the bottom part of the lower funnel dish is closed. The raw water after passing through the opening part of the bottom of the upper funnel dish rises. A trumpet type back-wash pipe into which the air pipe is inserted is installed in a neighbouring position of the bottom part of the lower funnel dish for collecting filtered water from a filtered-water collecting opening. In another prior art, the Chinese patent application CN210586114U discloses a washing unit with retrieve mechanism to provide general washing unit single structure in solving above-mentioned background art, during materials such as tiny iron fillings permeate through filter screen entering drainage pipe easily, the iron fillings gap is piled up easily and is cut the pipeline for a long time, and the iron fillings that are intercepted by the filter screen are clean inconvenient, and the problem of unable recovery. However, these prior arts failed to solve the cited problems in an efficient and effective manner, plus the set-ups are complicated and expensive. In light of the foregoing, there is a need for a filtration system that can solve the above-mentioned problems in an efficient and effective manner and which is easy to install and use without much limitation. Therefore, the embodiments of the present invention create a system to address the above.

### SUMMARY

It will be understood that this disclosure is not limited to the particular systems and methodologies described herein, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

It is an objective of the present invention to provide a filtration system that is configured to treat contaminated liquid for its purification so that the treated liquid can be used across various relevant applications. The filtration system includes devices for cleaning the contaminated water or keeping clear the surface of open water from oil or the like floating materials by separating or removing these materials from the water. The filtration system may include portable or detachable small-scale multistage treatment devices and may be implemented using household-type filters for producing potable filtration system. The filtration system is a gravity fed liquid treatment system and includes components such as a top liquid tank for holding untreated liquid and a bottom liquid tank for holding treated liquid. The filtration system further includes one or more filtration media containers and filtration columns. Each filtration column is a composition of the stacked filtration media containers. The untreated liquid may correspond to untreated greywater or any liquid that is contaminated with impurity and is required to be treated before use. Greywater is the wastewater generated from the process of a household appliance like a kitchen sink, shower, washing machine, or AC outlet.

Various embodiments create a liquid filtration system to the above needs and challenges that comprise of connected combinations of components that include liquid holding tanks, filtration media containers that hold filtration media, filtration column containers that stack filtration media containers, and a drop stop mechanism. For example, the filtration system includes a top liquid tank for holding untreated liquid. The top liquid tank includes one or more inlets for receiving the untreated liquid from a source and the top liquid tank includes one or more holes in its floor. The filtration system further includes a bottom liquid tank for holding treated liquid. The bottom liquid tank includes one or more outlets for sending the treated liquid to a destination. The filtration system further includes plurality of filtration media containers for holding a plurality of liquid filtration media. The filtration system further includes a filtration column that is a composition of the stacked filtration media containers with interleaved gaskets and a drop stop plate. The drop stop plate inhibits the filtration column from falling through the floor. The components are composable in multiple ways including at least stacking or parallel positioning. The filtration media container is configured to hold any filtration media in any physical form including solid, liquid, gaseous, or membrane.

The proposed gravity filtration system may be used with various electrical appliances such as washing machine and the process can be automated utilizing the Machine learning (ML) and Artificial Intelligence (AI) technology.

These and other features and advantages of the present invention will become apparent from the detailed description below, considering the accompanying drawings.

### BRIEF DESCRIPTION OF ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 is a diagram that illustrates a perspective view of a liquid filtration system, according to an exemplary embodiment of the present invention.

FIG. 2 is a diagram that illustrates a perspective view of a filtration media container component of the liquid filtration system, according to an exemplary embodiment of the present invention.

FIG. 3 is a diagram that illustrates an exploded view of a filtration column component of the liquid filtration system and illustrates stacking assembly, according to an exemplary embodiment of the present invention.

FIG. 4 is a diagram that illustrates a drop stop plate component of the filtration system, according to an exemplary embodiment of the present invention.

FIG. 5A is a diagram that illustrates an implementation setup for recycling of grey water using the liquid filtration system, according to an exemplary embodiment of the present invention.

FIG. 5B is a diagram that illustrates an implementation process for recycling of grey water using the liquid filtration system, according to an exemplary embodiment of the present invention.

FIG. 6A is a diagram that illustrates an implementation setup for using the liquid filtration system with a washing machine, according to an exemplary embodiment of the present invention.

FIG. 6B is a diagram that illustrates an implementation process for using the liquid filtration system with the washing machine, according to an exemplary embodiment of the present invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a liquid filtration system or apparatus or device for filtering greywater to obtain filtered or reusable water. The filtered water can be used in various applications such as for kitchen sinks, washing machine, and so on. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the present invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

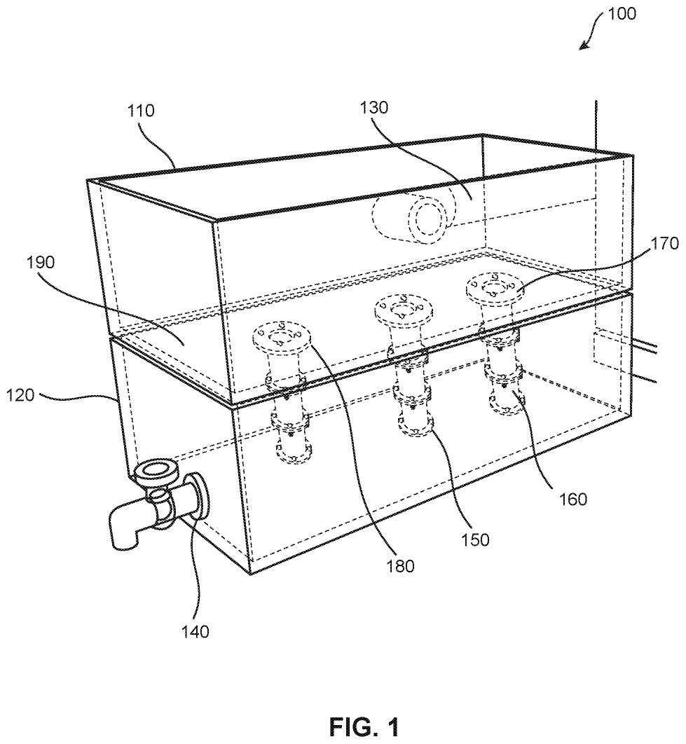

The liquid filtration system of the present invention will now be described with reference to the accompanying drawings, which should be regarded as merely illustrative without restricting the scope and ambit of the present invention. The liquid filtration system has been disclosed for facilitating filtering of greywater or any other liquid, which in turn can increase the possibility of reusing the water or liquid for various applicable applications, for example, washing, cooking, bathing, and so on, thereby helping save the water. The liquid filtration system also reduces the time, effort, and expense necessary to install and maintain the liquid filtration system. Embodiments of the present invention will now be described with reference to FIGS. 1-6.

FIG. 1 is a diagram that illustrates a perspective view of a liquid filtration system 100, according to an exemplary embodiment of the present invention. The filtration system is a gravity fed liquid treatment system and is used for treating untreated greywater or any liquid that is contaminated with impurity and is required to be treated before use. The liquid filtration system 100, hereinafter, may be referred to as the filtration system 100 or water filtration system 100 as applicable but should not be construed as limiting to the scope of the present invention. The filtration system 100 includes a plurality of components such as a top liquid holding tank 110 (hereinafter, the first or top tank 110), a bottom liquid holding tank 120 (hereinafter, the second or bottom tank 120), one or more inlets such as an inlet pipe 130, one or more outlets such as an outlet pipe 140, one or more columns such as a filtration column 150, and one or more containers such as filtration media containers 160. The filtration system 100 further includes one or more drop stop plates such as a drop stop plate 170, one or more holes such as drilled hole 180, and one or more floors such as a floor 190. As illustrated in FIG. 1, the filtration system 100 comprises of one or more top liquid holding tanks 110 and one or more bottom liquid holding tanks 120. The top tank 110 has the inlet 130 for receiving untreated liquid (such as greywater) from one or more sources. The bottom tank has the outlet 140 for storing the treated liquid, from which the treated liquid may be sent to a destination such as to a washing machine or a kitchen sink tap. The top tank 110 contains the one or more filtration columns 150 which are comprised of the one or more stacked filtration media containers 160. Each filtration column is attached to the respective drop stop plate component 170. The filtration column component 150 is inserted into the drilled holes 180 in the top tank floor 190. The diameter of the drop-stop plate 170 is greater than the drilled hole 180 in the bottom tank floor 190 so that the filtration column component 150 does not drop into bottom tank component 120. The untreated greywater in the top tank component 110 flows through one or more filtration column components 150. Treated liquid flows out of the filtration column component 150 and collects in the bottom tank component 140.

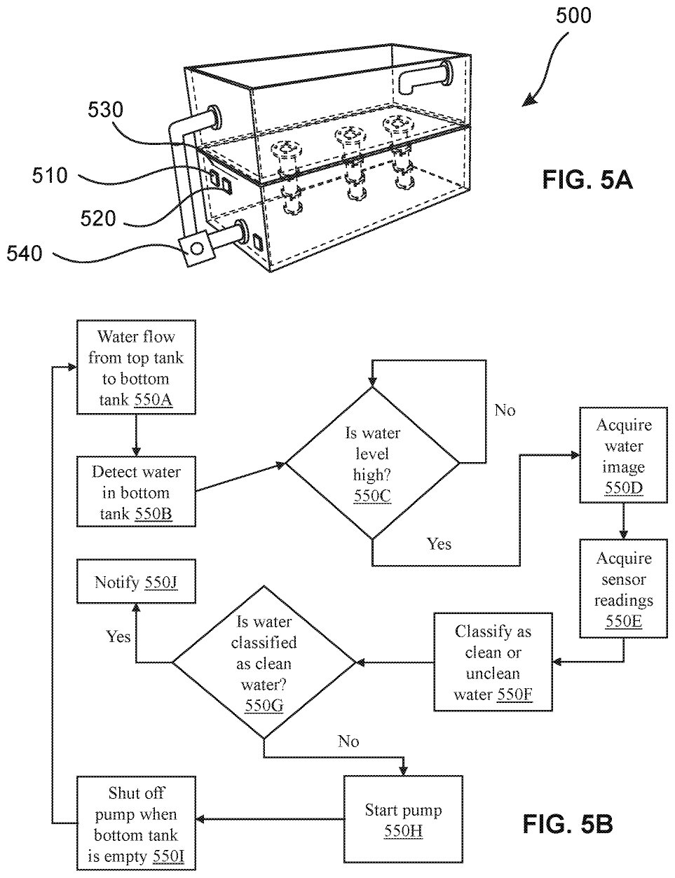

Thus, various embodiments of the present invention disclose the liquid filtration system 100 to tackle the needs and challenges that comprise of connected combinations of components that include the liquid holding tanks 110 and 120, the filtration media containers 160 that hold filtration media, the filtration column containers 150 that stack the filtration media containers 160, and the drop stop mechanism implemented using the drop stop plate 180. For example, the filtration system 100 includes the one or more tanks (the top tank 100 and the bottom tank 120) for receiving the unfiltered water and storing the filtered water. The tanks 110 and 120 may be arranged vertically or sidewise. In an example scenario of just having two tanks such as a first tank (the top tank 110) and a second tank (the bottom tank 120), the top tank 110 includes the one or more inlets (such as the inlet 130) for receiving the greywater (or any other contaminated liquid) and the bottom tank 120 includes the one or more outlets (such as the outlet 140) for filtered/clean water or liquid collected therein. The top tank 110 and the bottom tank 120 may have a common surface or floor with one or more holes. However, in some other examples, the top tank 110 and the bottom tank 120 may have separate surfaces or floors with one or more holes such that the holes in the separate surfaces or floors (i.e., a bottom floor of the top tank 110 and a top floor of the bottom tank 120) have the same alignment and are synching with other. From each of these holes, the filtration column 150 is suspended down to the bottom tank 120 using the holding plate i.e., the drop stop plate 180 such that the filtration column(s) 150 is not touching the bottom surface or floor of the bottom tank 120. The holding plate 180 may have a diameter greater than the hole so that the holding plate 180 is restricted from any motion under effect of gravity into the bottom tank 120. The holding plate 180 may be connected to the filtration column 150 using one or more fastening members which help the filtration column 150 to hang in the bottom tank 120 against the gravity. The filtration column 150 includes the one or more filtration media containers 160. Each filtration media container 160 is packed with suitable filtration substance (such as pebbles, active charcoal, sand, or the like). Suitable filtration substance is placed inside a cylindrical cavity of the filtration media container 160. A mesh may be provided in the bottom of the filtration media 160 for holding the filtration substance packed inside the cylindrical cavity of the filtration media 160. The proposed gravity filtration system may be used with various electrical appliances such as washing machine, kitchen sink, bathroom, or the like, and the process may also be automated by utilizing the Machine learning (ML) and Artificial Intelligence (AI) technology. This part of the present invention has been described later in detail in conjunction with FIGS. 5A and 5B.

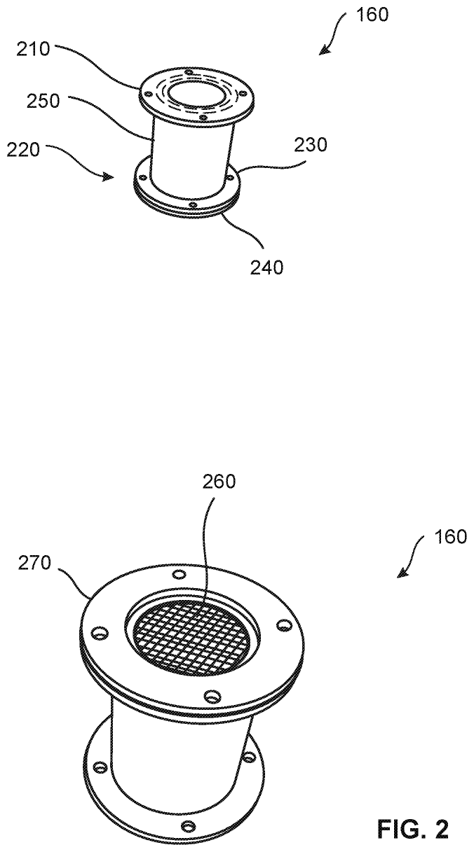

FIG. 2 is a diagram that illustrates a perspective view of the filtration media container 160 of the liquid filtration system 100, according to an exemplary embodiment of the present invention. The diagram illustrates the filtration media container 160 embodying the principles and concepts of an embodiment of the present disclosure. As illustrated in FIG. 2, the filtration media container 160 has an upper top flange 210 and a bottom lower flange 220. There is a lower mesh 260 within an inner pipe body 250 and just above the bottom lower flange 220. The bottom flange 220 may be connected to the top upper flange 210 of another filtration media container and secured with a plurality of screws and nuts assembly (for example, 4 screws and nuts) that are inserted through screw holes 230. A gasket 240 is inserted between the two connected flanges. The inner pipe body 250 contains the one or more type of the filtration media. The lower mesh 260 secures the filtration media and does not allow it to drop through. The number of filtration media container may be dependent upon the number of types of the filtration media that are required to be used for the filtration process. For example, if three (3) filtration media are to be used for executing the filtration process, then three (3) filtration media containers may be used and are stacked vertically in a column to form the filtration column 150. A person having ordinary skills in the art would understand that the disclosed filtration system 100 (as shown in FIG. 1) may be implemented by using one filtration column 150 but should not be construed as limiting to the scope of the present invention. In a preferred embodiment, at least two (2) filtration columns 150 should be used and these filtration columns 150 should be equally spaced inside the tanks for efficient and effective results. In an exemplary embodiment, the number of filtration columns 150 for use in the filtration system 100 may be dependent upon length, width, and height of each tank used with the filtration system 100.

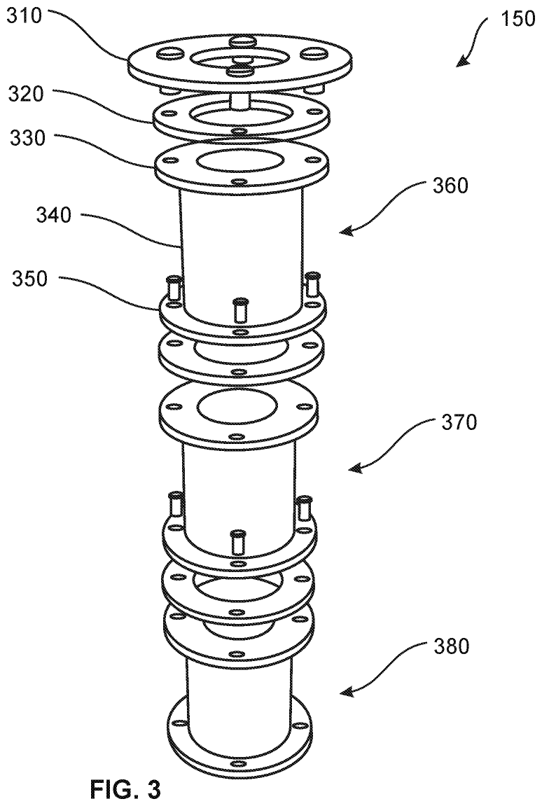

FIG. 3 is a diagram that illustrates an exploded view of the filtration column 150 of the liquid filtration system 100 and illustrates stacking assembly, according to an exemplary embodiment of the present invention. The diagram illustrates the filtration column 150 embodying the principles and concepts of an embodiment of the present disclosure. As illustrated in FIG. 3, the filtration column 150 is assembled by stacking and connecting the drop stop plate 310, multiple filtration media containers 360, 370, and 380, and interleaved gaskets 320. These components ate stacked and connected by means of the plurality of screws and nuts assemblies (for example, 4 screws and nuts) that are inserted through screw holes of the drop stop plate 310, interleaved gaskets 320, and the upper top flange 330. The connections use the screw and nut assemblies through the screw holes in the upper top flange 330 and the bottom lower flange 350. Untreated liquid (such as the greywater) enters the top stacked filtration media container component 360, flows through one or more stacked middle filtration container components 370, and flows out through the bottom stacked filtration media component 380. Each filtration media container pipe body 340 holds the filtration media in requisite quantity.

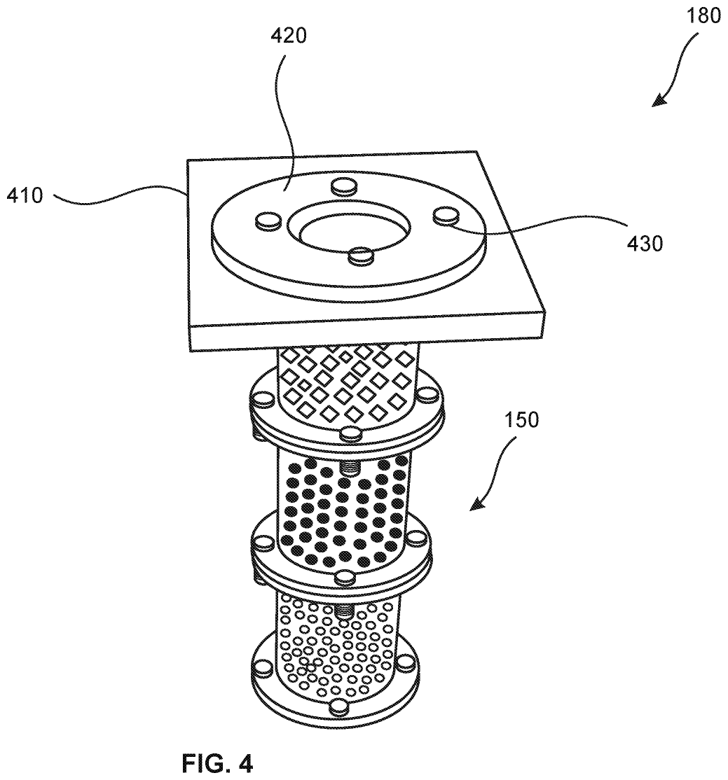

FIG. 4 is a diagram that illustrates the drop stop plate mechanism (i.e., the holding plate) 180 of the liquid filtration system 100, according to an exemplary embodiment of the present invention. The diagram illustrates the operation of the drop stop plate mechanism 180 embodying the principles and concepts of an embodiment of the present disclosure. As illustrated in FIG. 4, the drop stop plate 420 has a diameter greater than the diameter of the hole in the bottom of the upper tank floor 410. This design causes the filtration column component 150 not to fall through when inserted. The filtration column component 150 may be further secured to the floor of the upper tank component by multiple screw and nut assemblies. The untreated liquid (such as the greywater) enters the top stacked filtration media container component, flows through one or more stacked middle filtration container components, and flows out through the bottom stacked filtration media component. Each filtration media container pipe body holds the filtration media in requisite quantity. For example, the top stacked filtration media container component may include stones, the middle filtration container component may include charcoal, and the bottom stacked filtration media component may include sand. The filtration media may be placed in any order as per the usage preferences.

FIG. 5A is a diagram that illustrates an implementation setup for recycling of the grey water using the liquid filtration system 500, according to an exemplary embodiment of the present invention. The liquid filtration system 500 (as shown in FIG. 5) includes all the components of the liquid filtration system 100 (as shown in FIG. 1). In addition, the liquid filtration system 500 includes one or more image-capturing devices such as a camera 510, one or more sensors such as a sensor 520, and a water level indicator 530. The liquid filtration system 500 further includes a pumping system including a pump 540 and pipes that connect the tanks. For example, one pipe connects the bottom tank to the pump 540 and another pipe connects the pump 540 to the top tank as shown in FIG. 5. In an embodiment, the camera 510 may be configured to capture one or more images of the treated water in the bottom tank and then communicate the captured images to a central processing device or a remote server via a communication network. In an embodiment, the sensor 520 may be configured to measure one or more parameters such as pH, TPS, bacteria, or the like and then communicate the measured data to the central processing device or the remote server. In an embodiment, the water level indicator 530 may be implemented using one or more floats. A float switch is a device that is used to sense the level of liquid within a tank. In an embodiment, when triggered, the pump 540 may be configured to pump the treated water from the bottom tank to the top tank.

FIG. 5B is a diagram that illustrates an AI process for recycling of the grey water using the liquid filtration system 500, according to an exemplary embodiment of the present invention. At 550A, the liquid (such as the greywater) flows from the top tank to the bottom tank. At 550B, the water level indicator 530 detects the water and its level in the bottom tank. At 550C, a check is performed to determine whether the water level is high or not based on a predefined water level. For example, if the current water level is equal to or more than the predefined water level, then the water level is determined as high else low. If the water level is determined to be low, then the step 550C is executed again. However, if the water level is determined to be high, then the step 550D is executed. At 550D, the images captured by the camera 510 are acquired. At 550E, the sensor readings are acquired. Thereafter, at 550F, the central processing device or the remote server may be configured to process the acquired images and sensor readings and classify the treated water as clean or unclean water based on the processing. At 550G, another check is performed to determine whether the treated water is classified as clean or unclean water. If the treated water is classified as unclean water, then step 550H is executed. Else step 550J is executed in which a notification is generated and displayed and communicated to a remote device or a user device. At 550H, the pump 540 is automatically triggered to start. This causes the treated water to flow from the bottom tank to the top tank. At 5501, the pump 540 is automatically shut off when the bottom tank is identified to be empty. Post that, the above steps are continuously repeated until the treated water is classified as clean water.

The central processing device or the remote server is a computing machine, a software framework, or a combination thereof, that may provide a generalized approach to create the application server implementation. Examples of the computing machine include, but are not limited to, a personal computer, a laptop, or a network of computer systems. The computing machine may be realized through various web-based technologies such as, but not limited to, a Java web-framework, a .NET framework, a PHP (Hypertext Preprocessor) framework, or any other web-application framework. The computing machine may operate on one or more operating systems such as Windows, Android, Unix, Ubuntu, Mac OS, or the like. Various operations of the computing machine may be dedicated to execution of procedures, such as, but are not limited to, programs, routines, or scripts stored in one or more memory units for supporting its applied applications and performing one or more operations. The computing machine may also be realized as a machine-learning model or AI model that implements any suitable machine-learning techniques, statistical techniques, or probabilistic techniques. Examples of such techniques may include expert systems, fuzzy logic, support vector machines (SVM), Hidden Markov models (HMMs), greedy search algorithms, rule-based systems, Bayesian models (e.g., Bayesian networks), neural networks, decision tree learning methods, other non-linear training techniques, data fusion, utility-based analytical systems, or the like. Examples of the computing machine may include, but are not limited to, a personal computer, a laptop, or a network of computer systems.

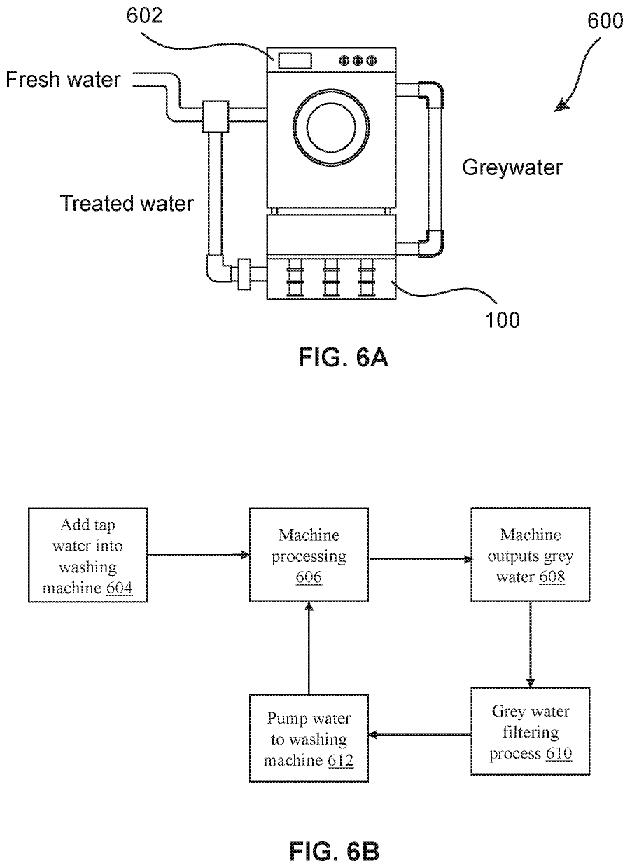

FIG. 6A is a diagram that illustrates an implementation setup 600 for using the liquid filtration system 100 with a washing machine 602, according to an exemplary embodiment of the present invention. FIG. 6B is a diagram that illustrates an implementation process for using the liquid filtration system 100 with the washing machine 602, according to an exemplary embodiment of the present invention.

As shown, the washing machine 602 receives the fresh water from a source, say a tap, as shown by 604. Then, the washing machine 602 processes the fresh water for cleaning purpose, as shown by 606. Post the completion of requisite cycle, the greywater flows from the washing machine 602 to the inlet of the liquid filtration system 100, as shown by 608. The liquid filtration system 100 processes the greywater to obtain the treated water, as shown by 610. The treated water flows from the liquid filtration system 100 to the washing machine 602. Then, the washing machine 602 uses the treated water with or without the fresh water to further process the cleaning process, as shown by 612.

Techniques consistent with the disclosure provide, among other features, the liquid filtration system. While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Although particular embodiments of the invention have been described in detail for purposes of illustration, various modifications and enhancements may be made without departing from the spirit and scope of the invention. The scope of the invention is accordingly defined by the following claims.

I claim:

1. A gravity fed liquid treatment system, comprising:
a plurality of components including:
a top liquid tank for holding untreated liquid, wherein the top liquid tank includes one or more inlets for receiving the untreated liquid from a source and wherein the top liquid tank includes one or more holes in its floor;
a bottom liquid tank for holding treated liquid, wherein the bottom liquid tank includes one or more outlets for sending the treated liquid to a destination;
a plurality of filtration media containers for holding a plurality of liquid filtration media; and
a filtration column that is a composition of the stacked filtration media containers with interleaved gaskets and a drop stop plate, wherein the drop stop plate inhibits the filtration column from falling through the floor.

2. The gravity fed liquid treatment system of claim 1, wherein the plurality of components is composable in multiple ways including at least stacking or parallel positioning.

3. The gravity fed liquid treatment system of claim 1, wherein the untreated liquid corresponds to untreated greywater or any liquid that is contaminated with impurity and is required to be treated before use.

4. The gravity fed liquid treatment system of claim 1, wherein the filtration media container is configured to hold any filtration media in any physical form including solid, liquid, gaseous, or membrane.

5. The gravity fed liquid treatment system of claim 1, further comprising one or more drop stop plates, one or more drilled holes, and one or more floors.

6. The gravity fed liquid treatment system of claim 5, wherein each filtration column is attached to the respective drop stop plate and the filtration column is inserted into a drilled hole in a top tank floor.

7. The gravity fed liquid treatment system of claim 5, wherein a diameter of the drop-stop plate is greater than the drilled hole in a bottom tank floor so that the filtration column does not drop into bottom tank component.

8. The gravity fed liquid treatment system of claim 1, wherein the untreated liquid in the top tank flows through one or more filtration columns and the treated liquid flows out of the filtration column and collects in the bottom tank.

9. The gravity fed liquid treatment system of claim 1, wherein the drop stop plate is connected to the filtration column using one or more fastening members which helps the filtration column to hang in the bottom tank against gravity.

10. The gravity fed liquid treatment system of claim 1, further comprising a mesh that is provided in the bottom of the filtration media for holding the filtration substance packed inside a cylindrical cavity of the filtration media.

11. The gravity fed liquid treatment system of claim 1, wherein the filtration media container has an upper top flange and a bottom lower flange and there is a lower mesh within an inner pipe body and just above the bottom lower flange.

12. The gravity fed liquid treatment system of claim 11, wherein the bottom flange is connected to the upper top flange of another filtration media container and secured with a plurality of screws and nuts assemblies that are inserted through screw holes.

13. The gravity fed liquid treatment system of claim 1, further comprising a camera, a sensor, a water level indicator, and a pump.

14. The gravity fed liquid treatment system of claim 13, wherein
the camera is configured to capture an image of the treated liquid in the bottom tank,
the sensor is configured to measure and read one or more parameters including pH, TPS, or bacteria in the treated liquid in the bottom tank, and
the water level indicator is configured to measure or indicate a level of the treated liquid in the bottom tank.

15. The gravity fed liquid treatment system of claim 14, wherein the captured image and sensor readings are processed to identify whether the treated liquid is clean or unclean liquid, and wherein the pump is configured to pump the treated liquid to the top tank from the bottom tank when it is determined that the treated liquid is unclean liquid.
